(19) United States
(12) Patent Application Publication
(10) Pub. No.: US 2007/0045238 A1
(43) Pub. Date: Mar. 1, 2007

(54) Method of welding material with reduced porosity

(75) Inventor: Wayne H. Tuttle, Torrance, CA (US)

Correspondence Address: CARLSON, GASKEY & OLDS, P.C., 400 WEST MAPLE ROAD, SUITE 350, BIRMINGHAM, MI, 48009, US

(73) Assignee: Hamilton Sundstrand

(21) Appl. No.: 11/214,349

(22) Filed: Aug. 29, 2005

(51) Int. Cl. B23K 9/167

(52) U.S. Cl. 219/75

(57) ABSTRACT

A welding method and apparatus is provided that is suitable for arc welding processes using shield gas. A weld area on an aluminum weldment is exposed to sulfur hexafluoride to chemically bind hydrogen in the weld area with the sulfur hexafluoride to reduce porosity.

### BACKGROUND OF THE INVENTION

This invention relates to a welding method and apparatus suitable for welding aluminum while greatly minimizing weld porosity.

Porosity in welds reduces the strength and integrity of the weld. As will be described in more detail below, porosity can occur in aluminum welding processes. Due to more stringent requirements for the quality of welds than in other industries, the aerospace industry has particular interest in reducing the porosity of aluminum welds.

The typical cause of porosity in aluminum welds is hydrogen filled voids forming during solidification of the weld puddle. The source of the hydrogen often comes from moisture on the surface of the aluminum, moisture absorbed in the tenacious surface oxide layer of the aluminum, moisture in the shielding gas, and hydrocarbon contamination on the surface of the aluminum. The hydrogen is dissociated from the water or hydrocarbons and enters the molten aluminum due to the high solubility of hydrogen in molten aluminum. The solubility further increases with increasing temperatures. As the weld puddle solidifies, excess hydrogen is rejected in small pores of hydrogen gas scattered through the aluminum. In some cases the pores will coalesce and grow to a point where they will float to the surface of the molten aluminum and escape. Any remaining hydrogen bubbles will remain trapped within the solid aluminum thereby forming the spherical porosity typical of aluminum welding.

One approach to reducing porosity in welding aluminum has been to eliminate the hydrogen sources by cleaning, drying, removal of the oxide layer, and etching of the weld area. Because the shielding gas can be a source of the hydrogen, the moisture content of the shielding gas and its purity are typically tightly controlled to eliminate the hydrogen. Despite these industry efforts, excessive porosity in aluminum welds still exists.

Another approach has been to use chlorine in the shield gas. The chlorine has been effective in removing the hydrogen, but it results in highly corrosive chlorine gas being released into the local atmosphere. When its successively removes the hydrogen, dry hydrochloric acid is released into the local atmosphere. The chlorine gas and hydrochloric acid, in addition to being an occupational exposure hazard, is a great corrosion risk to equipment and facilities.

Accordingly, what is needed an improved method and apparatus to reduce porosity in aluminum welds.

### SUMMARY OF THE INVENTION

The present invention relates to a welding apparatus and method for reducing the porosity of aluminum welds. Welding equipment that includes an electrode and a nozzle for delivering a shield gas is provided. An arc extends between an aluminum weldment and the electrode. The arc creates a weld puddle in a weld area of the aluminum weldment.

A tank including sulfur hexafluoride combines with hydrogen to reduce an amount of hydrogen in the weld area thereby reducing weld porosity. In one example, the sulfur hexafluoride may be part of a mixture within the tank that includes a base gas, such as a generally inert gas typically used for shielding. The mixture is delivered through the nozzle and becomes part of the plasma column, in addition to acting as the shielding gas.

In another embodiment, the aluminum weldment may be a tube having a cavity. The sulfur hexafluoride is arranged within the cavity and isolated from the arc. Sulfur hexafluoride may produce some undesirable byproducts in the presence of an arc. Having the sulfur hexafluoride contained within the cavity prevents the formation of these byproducts while still enabling the sulfur hexafluoride to pull hydrogen away from the weld area.

Therefore, an improved method and apparatus for reducing porosity in aluminum welds is provided. The method can be employed in arc welding processes that utilize shield gas, for example.

These and other features of the present invention can be best understood from the following specification and drawings, the following of which is a brief description.

### BRIEF DESCRIPTION OF THE DRAWINGS

FIG. 1 is a schematic view of one example of the inventive welding apparatus and method.

FIG. 2 is another example of the inventive welding apparatus and method.

FIG. 3 is another example of the welding apparatus and method using a modified back-up bar.

### DETAILED DESCRIPTION OF THE PREFERRED EMBODIMENT

The present invention and apparatus incorporates welding equipment that typically uses a shield gas to weld materials subject to formation of porosity due to hydrogen, such as aluminum and titanium. High-strength steels also benefit from reduced hydrogen during welding, since hydrogen is associated with “hydrogen embrittlement” and crack formation. The invention may be used for various types of welding equipment and processes such as gas tungsten arc welding (GTAW), gas metal arc welding (GMAW), plasma arc welding (PAW), soft plasma arc welding (SPAW), laser welding, and other arc welding processes that use shield gas. In arc welding processes, the plasma is the carrier of the electric current that heats the metal to be welded. The ionization of the shield gas in the open area between the electrode and the work piece provides the plasma.

Arc welding is a well known method of joining pieces of metal such as aluminum. The term aluminum is intended to include aluminum and its alloys. Some aluminum alloys are welded autogenously and others are welded with the addition of filler metal that may be of the same or different alloy to allow for changes in the weld geometry or physical and mechanical properties. For example, GTAW employs an arc that is struck between a non-consumable electrode and the weldment in an atmosphere of shielding gas. In PAW and SPAW, an arc is established between a non-consumable electrode and the weldment in a plasma column, which is created within the plasma torch with the plasma column and the local area of the weldment within an atmosphere of shielding gas. In GMAW, an arc is struck between a consumable electrode and the weldment in an atmosphere of shielding gas.

The present invention reduces the available hydrogen for absorption into the weld puddle by chemically binding it with constituents of a shield gas, such as sulfur hexafluoride. The inventive welding system and method is suitable for any number of welding processes such as those listed above relating to arc welding using shield gas.

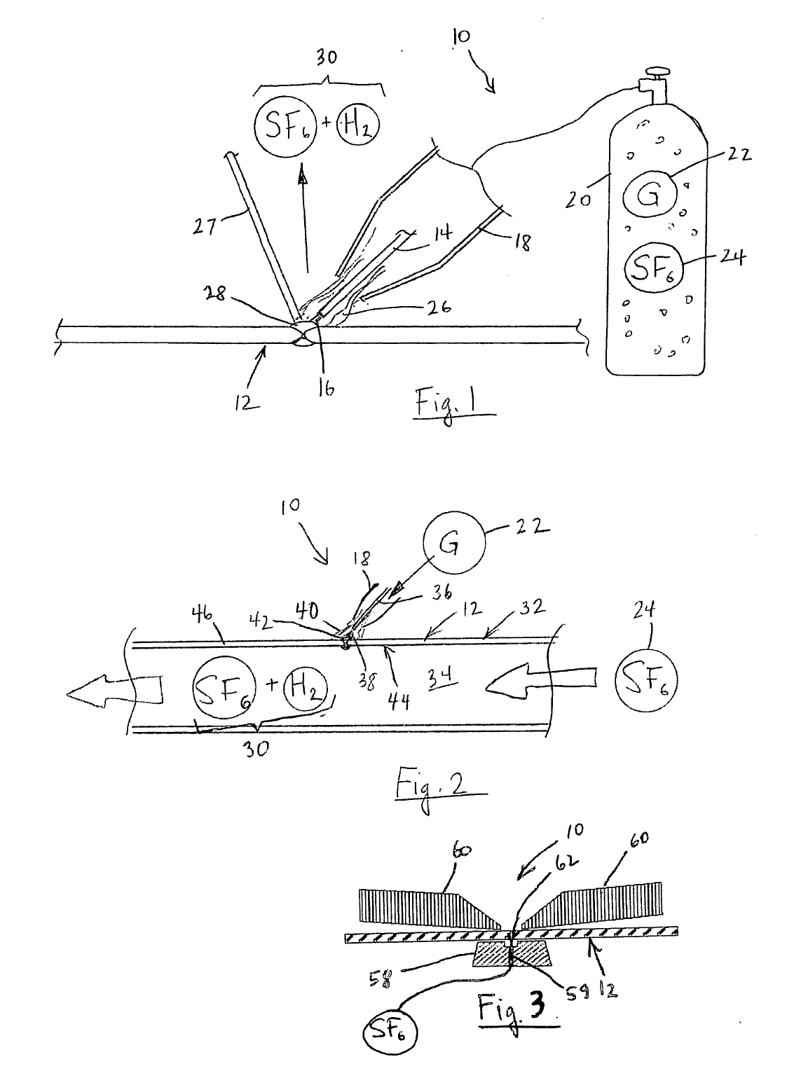

Referring to FIG. 1, welding equipment 10 is used to weld a metal such as an aluminum weldment 12. An electrode 14 generates an arc 16 between the electrode 14 and the aluminum weldment 12 by applying a current, as is well known in the art. A nozzle 18 is fluidly connected to a tank 20. In one example, the tank 20 includes a primary shield gas 22, or a base gas, mixed with sulfur hexafluoride (SF₆) 24. The primary shield gas is typically provided by a welding grade argon, helium, or a mixture of argon and helium. The base gas may also include carbon dioxide. Approximately between 0.1% to 50% sulfur hexafluoride may be mixed with the base gas. The addition of sulfur hexafluoride allows the normal arc welding process to take place with the arc voltage and the arc's electrical characteristics nearly unchanged from the original shield gas composition. Because the sulfur hexafluoride is part of the gas that makes up the arc plasma 26 and also surrounds the plasma column, it is in contact with any hydrogen that is made available through dissociation with the welding process. This effectively binds up the hydrogen so that it is no longer soluble in the molten aluminum weld puddle 28. With the hydrogen no longer available for absorption into the liquid, the aluminum does not develop a supersaturated condition during solidification, which eliminates the source of the pores.

A non-consumable electrode 14 is shown in FIG. 1. A filler material 27 can be added to the weld puddle 28, as is known in art. The sulfur hexafluoride chemically binds with the hydrogen in various forms to form byproducts 30.

Another example embodiment is shown in FIG. 2. The welding equipment 10 includes a consumable electrode 36 that generates an arc 42 between the electrode 36 and an enclosed weldment 32. The enclosed weldment 32 is a tube forming a cavity 34. The primary shield gas 22 is provided by the nozzle 18 forming a plasma column 40.

The sulfur hexafluoride 24 is provided within the cavity sufficient to provide coverage and ensure binding is possible. The weld puddle 42 may extend through a wall 46 to an inner side 44. The sulfur hexafluoride 24 within the cavity 34 pulls the hydrogen from the weld area to form the byproducts 30. However, the sulfur hexafluoride is isolated from the arc 38 so that some of the byproducts that may be undesirable are either not formed or contained within the cavity.

Another example of an embodiment is shown in FIG. 3. The welding equipment includes tooling that provides a purge cavity into which the weld puddle may extend and expand. The sulfur hexafluoride within the cavity pulls the hydrogen from the weld area to form byproducts. In FIG. 3, a backing bar 58 is typically used in a longitudinal seam welder. The weldment 12 is clamped to the backing bar 58 using clamps 60. The backing bar 58 is modified to include a longitudinal cavity 62 that is fed sulfur hexafluoride through a passage 59.

As in the embodiment described in FIG. 2, the embodiment shown in FIG. 3 isolates the sulfur hexafluoride from the arc so that some of the byproducts that may be undesirable are either not formed or contained within the cavity. This embodiment, like the one described in FIG. 2, can be modified to incorporate the use of mixtures of base gas and sulfur hexafluoride in the primary shield gas that constitutes the arc plasma.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of welding a material subject to formation of porosity due to hydrogen comprising:
a) creating an arc;
b) surrounding the arc with a mixture of a base gas and sulfur hexafluoride;
c) creating a plasma with the mixture; and
d) removing hydrogen with the plasma.

2. The method according to claim 1, wherein step a) includes creating an arc between an aluminum weldment and an electrode.

3. The method according to claim 1, wherein the base gas is a generally inert gas in the plasma.

4. The method according to claim 1, wherein step d) include forming byproducts with the sulfur hexafluoride and the hydrogen.

5. The method according to claim 1, wherein the mixture includes approximately between 0.1% and 50.0% sulfur hexafluoride.

6. The method of claim 1, wherein the material is aluminum or an aluminum alloy.

7. A method of welding a material subject to formation of porosity due to hydrogen comprising:
a) providing a cavity in fluid communication with a weldment;
b) providing sulfur hexafluoride to the cavity;
c) creating an arc exterior to the cavity for welding the weldment; and
d) removing hydrogen with the sulfur hexafluoride within the cavity.

8. The method according to claim 7, wherein step a) includes providing a tube.

9. The method according to claim 7, wherein step c) includes isolating the sulfur hexafluoride from the arc.

10. The method according to claim 7, wherein step d) include forming byproducts with the sulfur hexafluoride and the hydrogen within the cavity.

11. The method according to claim 6, wherein the material is aluminum or an aluminum alloy.

12. A welding system comprising:
a weldment made of a material subject to formation of porosity due to hydrogen;
welding equipment including an electrode, and a tank having sulfur hexafluoride;
an arc extending between the weldment and the electrode; and
a weld area provided on the weldment, the sulfur hexafluoride combining with hydrogen to reduce an amount of hydrogen in the weld area.

13. The welding system according to claim 12, wherein the welding equipment includes a nozzle with a base gas exiting the nozzle, the base gas forming a plasma surrounding the arc.

14. The welding system according to claim 13, wherein the tank includes a mixture of the base gas and the sulfur hexafluoride, the mixture forming the plasma.

15. The welding system according to claim 12, wherein the aluminum weldment is a tube, the sulfur hexafluoride arranged within the tube and isolated from the arc.

16. The welding system according to claim 12, wherein the electrode is consumable, the electrode becoming part of the weld area.

17. The welding system according to claim 12, wherein the base gas is a generally inert gas.

18. The welding system according to claim 12, wherein the tank includes approximately between 0.1% and 50% sulfur hexafluoride.

19. The welding system according to claim 12, wherein the weldment is aluminum or an aluminum alloy.

20. The welding system according to claim 12, wherein the material is subject to porosity due to hydrogen.
